(19) United States
(12) Patent Application Publication
(10) Pub. No.: US 2006/0158044 A1
(43) Pub. Date: Jul. 20, 2006

(54) Method for the dynamic configuration of an operator interface of a functional module

(76) Inventors: Maik Koehler, Neuendorf (DE); Reinhard Brunner, Freital (DE); Jens Reckwell, Lohr am Main (DE); Klaus Goldbach, Lohr am Main (DE); Stephan Schultze, Lohn am Main (DE)

Correspondence Address: KENYON & KENYON LLP, ONE BROADWAY, NEW YORK, NY, 10004, US

(21) Appl. No.: 11/300,865

(22) Filed: Dec. 14, 2005

(30) Foreign Application Priority Data
Dec. 18, 2004 (DE) 10 2004 061 063.0

(51) Int. Cl. H02H 11/00

(52) U.S. Cl. 307/326

(57) ABSTRACT

A method for the dynamic configuration of an operator interface for a functional module of a control platform, the functional module having a plurality of terminals for connecting activating quantities, in which application-specifically dynamically a first and a second group of terminals is selected from the plurality of terminals, the terminals of the first group are situated on the operator interface and displayed, and the terminals of the second group are hidden on the operator interface. In addition, the a corresponding operator interface, a computer program, a computer program product and a computer system are described.

### FIELD OF THE INVENTION

The present invention relates to a method for the dynamic configuration of an operator interface of a functional module of a control platform, a corresponding computer program, a computer program product and a computer system for carrying out the method, as well as a corresponding operator interface of a functional module.

### BACKGROUND INFORMATION

In so-called SPS (memory programmable control) programming systems based on IEC 61131-3, there are so-called “program organization units” which correspond to program language structuring elements. In this context, one distinguishes between programs, functional modules, functions and additional units, such as resources. Each program organization unit, according to IEC, has certain specific properties which distinguish it from other program organization units. Greater detail on this matter is described and defined in DIN IEC EN 61131-3.

For a program coding and assignment of parameters of so-called motion/logic elements, the functional modules named are used, in particular. Functional modules are addressable within programs, other functional modules or directly from a resource. Functional modules have input parameters and output parameters. They differ from functions, on the one hand, by the linguistic invocation (call), that is, the syntax by which they are addressable, and on the other hand, in that functional modules, in contrast to functions, may have internal states. Accordingly, a configuration of the outputs of a functional module takes place as a function of the input configuration and the internal state parameters of the functional parameter of the functional module. For this reason, functional modules are instantiated, that is, in the case of a program organization unit that is supposed to use a specific functional module, a corresponding variable is declared to which an appropriate specific functional module type is assigned. In this context, an invoking of a respective functional module takes place in the implementation. Different SPS programming languages may be used in this context. One distinguishes, in this case, between graphic and textual programming languages. In the case of graphic programming languages there is, for example, a so-called functional module language (FBS) and a ladder diagram (KOP(LD)).

Among the group of textual programming languages there are, for instance, the statement list and the structured text. Representation of functional modules in graphic programming languages is standardized within IEC. Such a representation is shown in FIG. 1. It shows a functional module 1 in the form of a rectangle. The rectangle represents an operator interface 2 of functional module 1. In the current example, operational interface 2 has altogether 4 terminals, two input terminals E1, E2 and two output terminals A1, A2 being involved. Input and output parameters, i.e. variables, are displayed at the correspondingly shown connecting lines (not shown here). Furthermore, it is also possible to add functional modules, logical operations or functions to the inputs (E1, E2) and outputs (A1, A2). The representation of the operator interface of a functional module shown here has a series of disadvantages. An ever closer moving together of motion functionality and SPS functionality, a so-called motion-logic integration, calls for an invoking of different so-called motion modules, besides the use of usual functional modules. The motion modules differ from the usual functional modules in that, in particular, modules for the control of complex motion procedures mostly have a very large number of inputs and outputs, that is, of terminals, and at these terminals there are mostly variables that are used to parameterize predefined functionalities. In the case of these predefined functionalities, for example, motion, control response and cam disk characteristics may be involved.

Currently, motion control motions, so-called “canned functions”, in the operator interface shown in FIG. 1, have very many motion-conditioned inputs and outputs. There might be names, for instance, a virtual master axis, a cam disk and a register controller. A virtual master axis could, for example, be described by 25 parameters, 15 inputs and 12 outputs, which would yield a functional module having altogether 52 terminals. A cam disk, for example, includes 35 parameters, 14 inputs and 17 outputs, which would lead to a functional module having 66 terminals, and a register controller, for instance, includes 25 parameters, 4 inputs and 6 outputs, from which a functional module having 35 terminals would result. If such a functional module were equipped with an operator interface as shown in FIG. 1, this operator interface would be very unclear, since, as a rule, only some of the plurality of terminals are required in the SPS program. The majority of the terminals named usually remain open-circuited. In this context, either fixed parameter values are involved which require a one-time initial initialization, or inputs or outputs of non-utilized subfunctionalities of the respective functional module. Up to this point, there are some SPS programming systems, such as the so-called RSLogix system which, for the reasons given, already offer a possibility of a reduced representation of complex functional modules. In this case, buttons “more” and “less” are provided on the operator interface, via which the respective functional module may be displayed completely or in reduced fashion, in terms of its terminals. In addition, buttons are provided, via which further parameterizations may be undertaken. One disadvantage of the systems known at this time is that there are essentially only two scaling possibilities. This means that there is only the possibility of selecting between complete and reduced representation of the respective functional module. Furthermore, a user of the functional module cannot himself design the reduced representation on the operator interface of the functional module. Connection of security-relevant inputs and outputs is currently possible also in an unauthorized case. This means that any programmers are able to make a connection. Assigning parameters is started separately by a plurality of buttons provided for this. Using this, it is not possible to assign parameters in a method customary for classical motion control, via dialog chains, so-called wizards.

### SUMMARY OF THE INVENTION

Against the background of the above-discussed systems, the present invention now provides a method for the dynamic configuration of an operator interface of a functional module of a control platform, having the features described herein, a computer program having the features described herein, a computer program product having the features described herein, a computer program having the features described herein, as well as an operator interface having the features described herein.

According to the exemplary embodiment and/or exemplary method of the present invention, a method is provided for the dynamic configuration of an operator interface of a functional module of a control platform, the functional module having a plurality of terminals for connecting actuating quantities, and in the method, specific as to use and dynamically a first and a second group of terminals are selected from the plurality of terminals, the terminals of the first group are situated on the operator interface and displayed, and the terminals of the second group are hidden (faded out).

In one exemplary method according to the present invention, the majority of the terminals of the functional module is formed exactly from the first and the second group of the terminals.

In another exemplary method according to the present invention, at least one of the terminals of the second group is parameterized via at least one dialog able to be carried out via the operator interface, a so-called wizard.

In another exemplary method of the present invention, that at least one of the terminals of the second group does not become connected. It may be in this case, that a fixed parameter value is assigned to the at least one terminal, or that this terminal is not utilized for a special application of the functional module.

Furthermore, in another exemplary method according to the present invention, the terminals of the second group are pre-initialized to the variables that are to be connected to these terminals. Based on this pre-initialization, the terminals accordingly need not be considered any more for the further use of the functional module, and may accordingly be hidden on the operator interface. When it comes to the variables to be connected to the terminals, in this context, an additional program organization unit, such as a program, may be involved, or a function, an additional functional module or even a resource may be involved. One may initialize the terminals of the second group at such a point of use of the functional module entity in the program organization unit that is to invoke the functional module.

In complex, large functional modules, such an executed dynamic configuration of the operator interface leads to a substantially better overall view for a user. In this context, the number of visible terminals, that is, of the inputs/outputs of the functional module, may be reduced to a degree that is required for a specific application. The remaining terminals, that is, the terminals of the second group, are, in this context, either parameterized via dialogs, are unconnected or are not able to be reached at all. According to the method of the present invention, conceivably already during the programming of the functional module one might undertake a predefinition of a reduced representation on the operator interface, which is passed along with the functional module as a property. In this context, in addition, one might also undertake an initialization of the terminals of the second group which will have an effect on all the variables using the functional module.

A configuration of a reduced representation of the operator interface and an initialization of the hidden terminals may also be provided, at the variable using the functional module, that is, at the place of use of the functional module entity in a corresponding program organization unit invoking the functional module. Such an executed configuration/initialization of the functional module entity could, in this context, overwrite a possibly predefined configuration/initialization of the functional module, for example.

In another exemplary method according to the present invention, during a use of the functional module, terminals of the first group are optionally hidden and/or terminals of the second group are unhidden.

Moreover, the terminals of the second group may be displayed, for instance, via a separate display, especially an editor.

In an exemplary method according to the present invention, a switchover device is provided via which the predefined terminals of the second group may optionally be unhidden and hidden. In this context, the switchover device is provided, for example, at the entities invoking the functional module.

In another exemplary method according to the present invention, the selection of the first and the second group, and an optional unhiding and hiding of terminals of the first and/or the second group is carried out totally or only partially authorized. This means that not every user is able to undertake a selection and/or an unhiding or hiding of terminals, but rather has to be authorized to do this. Such an authorization may be implemented by assigning one or more passwords. Furthermore, it is conceivable to set up a stepwise authorization, that is, to differentiate between undertaking a complete unhiding and hiding or only a partial unhiding and hiding of the terminals. By doing this, the complete display and/or editing by password may be partially or completely locked, so that security-relevant parameterizations, for instance, may be protected in this way. If, for example, a reduction and preinitialization of a functional module is protected by using a password, it is true that the display may be still further reduced on the part of an unauthorized user, but terminals that have already been hidden are not unhidden again, whereby existing security settings cannot be violated, for example.

Using the exemplary method according to the present invention, functional modules have a compact and well arranged operator interface, and this applies also to the logic in their environment in a programming system. A reduced number of functional module inputs and outputs that are to be interconnected makes possible a simpler operation to a user, and thus reduces the probability of errors. By using the method according to the present invention, it is moreover conceivable that a manufacturer/supplier of a functional module, when delivering it, has already equipped it with a reduced graphic operator interface, the operator interface displaying only the essential terminals that are needed as a rule, and hiding or covering up the terminals that are rarely used. In this context, it is conceivable that, on the part of the user, the terminals of the functional module on the operator interface may be further reduced, in response to the invoking of the functional module entity. Moreover, security-relevant functional module terminals may be hidden by password, and therefore an erroneous connection may be prevented.

The exemplary embodiment of the present invention is also to an operator interface for a functional module of a control platform, the functional module having a plurality of terminals for connecting actuating quantities. The operator interface displays an application-specific, dynamically selectable first group of terminals of the plurality of terminals in a dynamically determinable arrangement, while it hides a second group of the plurality of terminals.

In an exemplary embodiment of the operator interface according to the present invention, a command button is provided, via which a dialog can be initiated via which at least one of the terminals of the second group is parameterizable.

In another exemplary embodiment of the operator interface according to the present invention, the operator interface has a second command button via which a display may be activated that displays the terminals of the second group.

The operator interface may have a switchover device, via which predefined terminals of the second group are optionally able to be unhidden and hidden.

The exemplary embodiment and/or exemplary method of the present invention also relates to a computer program having program code which is suitable for carrying out an exemplary method according to the present invention, if it is run on a computer or a computer system.

In addition, exemplary embodiment and or exemplary method of the present invention provides to a computer program product having program code, the program code being stored on a computer-readable data carrier, in order to carry out the exemplary method according to the present invention when the computer program is executed on a computer.

Over and above that, the exemplary embodiment and/or exemplary method of the present invention relates to a computer system having at least one memory unit in which a computer program having program code is stored, which, when run on a computer or on a computer system, is suitable for carrying out the exemplary method according to the present invention.

Further advantages and refinements of the present invention are described in the description herein and the accompanying drawings.

It is understood that the aforementioned features and those still to be described below may be used not only in the combinations specifically indicated but also in other combinations, or alone, without departing from the scope of the present invention.

### BRIEF DESCRIPTION OF THE DRAWINGS

FIG. 1 shows a statement list and a structured text, and a representation of functional modules in graphic programming languages, which is standardized within IEC, and which is shown as a functional module 1 in the form of a rectangle.

FIG. 2 shows an exemplary embodiment of the sequence of an exemplary method according to the present invention, in a schematic representation.

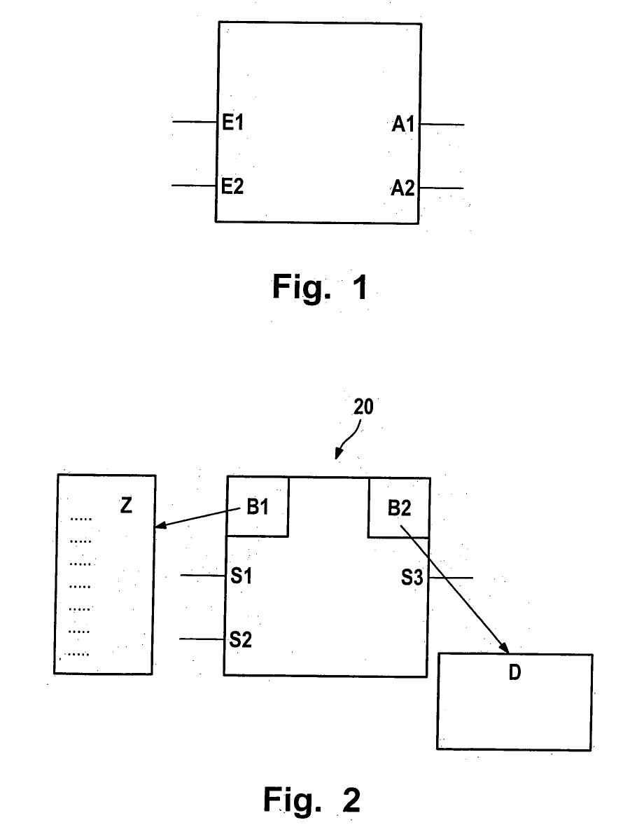

### DETAILED DESCRIPTION

FIG. 2 shows an operator interface 20 of a functional module of a control platform. The functional module has a plurality of terminals. In this context, three terminals S1, S2 and S3 were selected, situated on the operator interface and displayed. Furthermore, two buttons B1 and B2 are shown by which additional configuration possibilities of operator interface 20 are ensured. An operator interface 20, as shown here, may be pre-specified or predefined by a programmer of the functional module type, for example. In this context, the possibility also exists that some of the terminals of the functional model that are hidden here have already been pre-initialized. Because of buttons B1 and B2, the unhidden terminals of the functional module may be reduced.

Such a design arrangement may be implemented by a user at the place or the variable in the program code invoking the functional module entity. By a double click on button B1, for example, the potential user may now make visible a display of the currently hidden terminal. Via display Z, which includes a list of the hidden terminals, a user is now directly able to make a selection as to which of the currently hidden terminals are to be made visible, that is, unhidden. The size of the functional module may be determined thereby. In this context, the unhiding/hiding of terminals is supposed to be revocable by the user at any time. Moreover, via a double click on button B2, a dialog chain D may be opened on the part of the user. Dialog chain D makes it possible for a user interactively to undertake a parameterization of the currently non-visible terminals. In order to avoid that anyone is able to undertake a new configuration of operator interface 20, it may be provided by a password protection, for example, that only users that are authorized for it have the possibility of undertaking configurations of operator interface 20. In this context, such a password protection should exist especially to protect against the editing of initial values and/or against unhiding covered terminals.

In this context, the password that has been set up may be able to be entered during a parameterization of the functional module type, that is, when it is being prepared, and during the use, that is the invoking of its functional module entity. This ensures that, both at the preparation of the functional module, i.e. at its programming, as well as during its use, it is not possible to make an unauthorized reconfiguration of operator interface 20. Using the method according to the present invention, it is possible to input non-connected but used terminals in a user-friendly manner.

Moreover, a user-friendly hiding of nonrelevant terminals comes about in an especially flexible and application-specific manner. The method according to the present invention makes possible for a user flexible, user-defined design possibilities for the reduced functional module and the connection of terminals that are covered or hidden, respectively. Furthermore, there is the possibility of starting a dialog chain, a so-called wizard, via a command button. By providing a password, the protection of security-relevant functional module terminals is also ensured.

What is claimed is:

1. A method for dynamically configuring an operator interface for a functional module of a control platform, the functional module having a plurality of terminals for connecting activating quantities, the method comprising:
selecting dynamically and application-specifically a first group of terminals and a second group of terminals from the plurality of terminals;
wherein terminals of the first group are situated on the operator interface and are displayed, and terminals of the second group are hidden on the operator interface.

2. The method of claim 1, wherein the plurality of the terminals of the functional module is formed from the first and the second group of the terminals.

3. The method of claim 1, wherein at least one of the terminals of the second group are parameterized via at least one dialog that is performed via the operator interface.

4. The method of claim 1, wherein at least one of the terminals of the second group is not connected.

5. The method of claim 4, wherein the at least one non-connected terminal of the second group is pre-initialized.

6. The method of claim 1, wherein at least one of the following is satisfied: (a) the terminals of the first group are hidden; and (b) the terminals of the second group are unhidden during an application of the functional module.

7. The method of claim 1, wherein a separate display, which includes an editor, is provided, via which the terminals of the second group are displayable.

8. The method of claim 1, wherein a switchover device is provided via which predefined terminals of the second group are one of unhidden and hidden.

9. The method of claim 8, wherein the switchover device is provided at entities invoking the functional module.

10. The method of claim 1, wherein at least one of (a) a selection of the first and the second group and (b) an unhiding or hiding of the terminals of at least one of the first group and the second group is performed at least partially only if authorized, using a password.

11. A computer readable medium having a computer program having program code, executable on a computer, for dynamically configuring an operator interface for a functional module of a control platform, the functional module having a plurality of terminals for connecting activating quantities, by performing the following:
selecting dynamically and application-specifically a first group of terminals and a second group of terminals from the plurality of terminals;
wherein terminals of the first group are situated on the operator interface and are displayed, and terminals of the second group are hidden on the operator interface.

11. A computer readable data carrier having a computer program having program code, executable on a computer, for dynamically configuring an operator interface for a functional module of a control platform, the functional module having a plurality of terminals for connecting activating quantities, by performing the following:
selecting dynamically and application-specifically a first group of terminals and a second group of terminals from the plurality of terminals;
wherein terminals of the first group are situated on the operator interface and are displayed, and terminals of the second group are hidden on the operator interface.

13. A computer system comprising:
a memory unit for storing a computer program having program code, executable on a computer, for dynamically configuring an operator interface for a functional module of a control platform, the functional module having a plurality of terminals for connecting activating quantities, by performing the following:
selecting dynamically and application-specifically a first group of terminals and a second group of terminals from the plurality of terminals;
wherein terminals of the first group are situated on the operator interface and are displayed, and terminals of the second group are hidden on the operator interface.

14. An operator interface of a functional module of a control platform, the functional module having a plurality of terminals for connecting activating quantities, comprising:
a display arrangement for the operator interface to display application-specifically and dynamically selectably a first group of terminals from the plurality of terminals in a dynamically definable arrangement and to hide a second group from the plurality of terminals.

15. The operator interface of claim 14, wherein at least one of the terminals of the second group is parameterizable via a dialog that is initiatable via a first command button.

16. The operator interface of claim 15, wherein a display is activatable via a second command button, which displays the terminals of the second group.

17. The operator interface of claim 14, further comprising:
a switchover device, via which predefined terminals of the group are may be one of unhidden and hidden.
